(19) United States
(12) Patent Application Publication
(10) Pub. No.: US 2005/0047883 A1
(43) Pub. Date: Mar. 3, 2005

(54) Interchangeable boring bar system

(76) Inventor: William R. Bixler, Jonestown, PA (US)

Correspondence Address: Jeffrey S. Habib, Esq.;Hooker & Habib, P.C., Suite 304, 100 Chestnut St., Harrisburg, PA, 17101, US

(21) Appl. No.: 10/925,785

(22) Filed: Aug. 25, 2004

Related U.S. Application Data
(60) Provisional application No. 60/498,263, filed on Aug. 26, 2003.
(60) Provisional application No. 60/505,626, filed on Sep. 24, 2003.
(60) Provisional application No. 60/510,853, filed on Oct. 14, 2003.

(51) Int. Cl. B23B 29/02

(52) U.S. Cl. 408/224

(57) ABSTRACT

An interchangeable boring bar system for positioning implement holders at user-selected radial and axial positions along the boring bar includes an extendable boring bar defining an axis and a number of center stations that slidably mount on the boring bar. Annular collars on the bar axially position the center stations at the desired axial positions along the bar. Each implement holder is carried on a wing that is removably mounted on a center station and positions the implement holder the desired radial distance from the bar.

This application claims the benefit of U.S. Provisional Patent Application No. 60/498,263 filed Aug. 26, 2003, U.S. Provisional Patent Application No. 60/505,626 filed Sep. 24, 2003, and U.S. Provisional Patent Application No. 60/510,853 filed Oct. 14, 2003.

### BACKGROUND

This invention relates to boring bars, specifically to boring bars that enable users to arrange or configure the components of the boring bar to perform multiple operations at one time.

### DESCRIPTION OF THE PRIOR ART

Boring bars are costly. Multiple operations require a number of boring bars to complete the operations, increasing manufacturing costs. Using multiple boring bars also increases the time to complete the multiple operations.

### BRIEF SUMMARY OF THE INVENTION

The invention is an interchangeable boring bar system having the capability of performing multiple operations in one step. The system's attributes are modularity, interchangeability, multi-functionality, multiple step capability, and micro-adjustability. This is a stackable system in that multiple operations can be machined on one bar. This is achieved by adding additional tools in the desired space along the length of the bar and for the different machining diameters needed.

An embodiment of the interchangeable boring bar system in accordance with the present invention includes:
a boring bar being the main body of the interchangeable boring bar system, the boring bar including a boring bar slug and optionally one or more bar extensions to increase the length of the boring bar;
a number of multiple length collars with coolant channels overlying the boring bar, the collars spaced as necessary for the specific job function, the coolant channels supplying coolant in contrast to conventional borings bars that supply coolant only through the center of bar;
at least one center station with an adjusting nut, the center station and nut overlaying the boring bar, the center station and the nut having coolant channels supplying coolant, the center stations and nuts spaced as necessary for the specific job function;
an end cap attached to the end of the boring bar to fixedly locate the collars, center stations, and adjusting nuts along the boring bar;
one or more wings attached to each center station, each wing of a selected length, positioned as necessary for the specific job function;
either an implement holder and an implement holder spacer or an implement holder alone, attached to the end of each wing or to the end cap, adjusted out as necessary for the specific job function;
optional attachments that may be placed on the end of the boring bar in addition to or instead of the end cap, including milling tools, turning tools, facing tools, drills, reams, center drills, taps, threading mills, grooving tools, slotting tools, spade blade tools, chamfering tools, deburring tools, countersinking tools, grinding tools, traditional boring bars, tool holders, flex collets, three jaw chuck, tapping head, or an end cap;
optional devices which may be used as implement holders are holders configured as or removably mounting implements that are reams, reaming devices, reaming holders, burnishers, burnishing devices, burnishing holders, sanders, sanding devices, sanding holders, grinding devices, grinding holders, cutting insert holders, and the like; and
optional coolant supply or means of supplying coolant to the working surfaces that include, but are not limited to, adjustable directional coolant lines, use of flood coolant, and optional attachments that may be placed on the bar extensions or end cap;
whereby:
(a) when needed, multiple operations and configurations may be performed by the interchangeable boring bar system by attaching the above components and or optional attachments together, spaced as necessary to perform the job function;
(b) coolant supply is routed through the collars, center stations, wings, implement holders, and implement holder spacers to enable coolant to reach the working surfaces;
(c) when set up the system can cut multiple operations in one pass;
(d) when completed with a first job function, the interchangeable boring bar system may be reconfigured using the above components and or optional attachments to perform a next needed job function, thereby giving the user much more versatility than conventional boring bars.

Rough adjustments in length or axial position between implements or cutting tools are achieved by different size collars or implement holder spacers. Micro-adjustments in axial positioning of implements or cutting tools along the boring bar are preferably achieved through the adjusting nut. Rough adjustments in diameters are preferably achieved by adding a different wing size between the center station and the implement holder or implement holder spacer. Micro-adjustments in diameters are preferably achieved through a fine diameter adjustment device carried on each wing.

In a preferred embodiment of the boring bar system the implement holder is an insert cartridge that removably mounts a conventional cutting insert. Typical inserts have cutters formed from carbide, ceramic, high speed steel, and the like, but inserts are not limited to any particular current or future cutting material.

The boring bar is preferably cylindrical with circular cross section perimeters, but in other embodiments the boring bar can have a triangular, polygonal, oval, or other cross-section shape. The parts attached to the boring bar would have shapes or bores that cooperatively conform to the cross-section shape of the boring bar intended to be used with such parts to slide on or otherwise attach to the boring bar.

The center stations are preferably configured to attach two wings to each station, but other embodiments may have only one wing or more than two wings attached to each. Center stations configured to mount different numbers of wings or different types of wings can be used together on the boring bar.

Another feature of the present invention is the ability to make fine radial and axial positioning adjustments of the boring bar attachments on the boring bar.

Yet another feature of the present invention is that coolant can be flowed in an improved manner through the boring bar system.

Yet a further feature of the present invention is that multiple bores, each having a different bore diameter, can be bored simultaneously in a workpiece.

Yet an additional feature of the present invention is that multiple cutting or finishing operations can be conducted simultaneously on a workpiece.

Accordingly several objects and advantages of the invention are to provide a system with the capability of building a job-specific boring bar with multiple diameters, to provide the capability of sequencing multiple cutters or tools along different lengths of the boring bar, to provide the capability of machining multiple operations at one time, coolant channels allowing coolant delivery through collars and center stations to enable coolant supply for the cutting or working surfaces, and to provide the capability of readjusting, reconfiguring, or interchanging the boring bar for the next job. Still further objects and advantages will become apparent from a study of the following description and the accompanying 11 sheets of drawings illustrating an embodiment of the invention.

### BRIEF DESCRIPTION OF THE DRAWINGS

FIG. 1 is a front view of a boring bar assembly in accordance with the present invention;

FIG. 2 is an end view of the boring bar assembly taken along line 2-2 of FIG. 1;

FIG. 3 is a partially-exploded front view of the boring bar assembly;

FIG. 4 is a front view of the boring bar slug of the boring bar assembly;

FIG. 5 is an end view of the boring bar slug taken along line 5-5 of FIG. 4;

FIG. 6 is a sectional view of the boring bar slug taken along line 6-6 of FIG. 4;

FIG. 7 is a front view of a bar extension of the boring bar assembly;

FIG. 8 is an end view of the bar extension taken along line 8-8 of FIG. 7;

FIG. 9 is a sectional view of the bar extension taken along line 9-9 of FIG. 8;

FIG. 10 is a front view of a center station of the boring bar assembly;

FIG. 11 is an inboard side view of the center station;

FIG. 12 is an outboard side view of the center station;

FIG. 13 is a rear view of the center station;

FIG. 14 is a bottom view of the center station;

FIG. 15 is a sectional view of the center station taken along line 15-15 of FIG. 13;

FIG. 16 is a front view of an adjusting nut associated with the center station shown in FIG. 10;

FIG. 17 is an inboard side view of the adjusting nut;

FIG. 18 is an outboard side view of the adjusting nut;

FIG. 19 is a front view of a wing of the boring bar assembly;

FIG. 20 is an inboard side view of the wing;

FIG. 21 is a sectional view of the wing taken along line 21-21 of FIG. 20;

FIG. 22 is an outboard side view of the wing;

FIG. 23 is a top view of the wing;

FIG. 24 is a bottom view of the wing;

FIG. 25 is a front view of an indexible insert cartridge of the boring bar assembly;

FIG. 26 is an inboard side view of the insert cartridge;

FIG. 27 is an outboard side view of the insert cartridge;

FIG. 28 is a top view of the insert cartridge;

FIG. 29 is a front view of a fine diameter adjustment device associated with the wing shown in FIG. 19;

FIG. 30 is a vertical sectional view of the fine diameter adjustment device taken along line 30-30 of FIG. 29;

FIG. 31 is a front view of an indexible insert cartridge spacer of the boring bar assembly;

FIG. 32 is an inboard side view of the insert cartridge spacer;

FIG. 33 is an outboard side view of the insert cartridge spacer;

FIG. 34 is a top view of the insert cartridge spacer;

FIG. 35 is a front view of a collar of the boring bar assembly;

FIG. 36 is an inboard side view of the collar, the outboard side view being identical;

FIG. 37 is a sectional view of the collar taken along line 37-37 of FIG. 36;

FIG. 38 is a front view of the end cap of the boring bar assembly;

FIG. 39 is an inboard side view of the end cap;

FIG. 40 is an outboard side view of the end cap; and

FIG. 41 is a rear view of the end cap.

### DETAILED DESCRIPTION OF THE PREFERRED EMBODIMENT

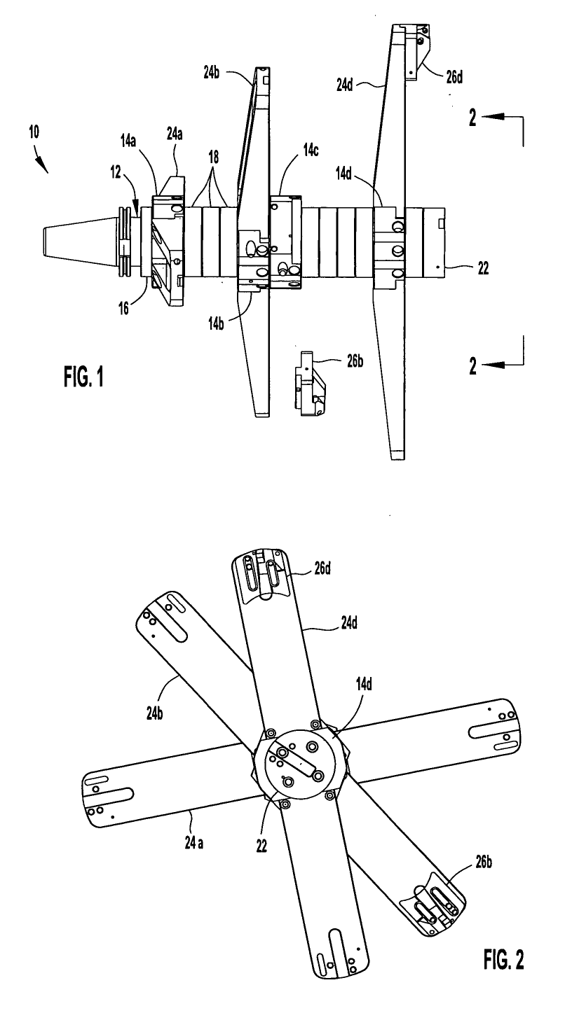

FIGS. 1-3 illustrate a boring bar assembly 10 in accordance with the present invention. Boring bar assembly 10 includes a boring bar 12 that supports four center stations 14a, 14b, 14c, and 14d spaced along the length of the bar. Center station 14a abuts an enlarged-diameter shoulder 16 on the inboard upper end of the boring bar. Spacers or collars 18 establish the gross axial locations of the other center stations 14b-d along the boring bar away from the shoulder 16. The collars 18 may be manufactured or stacked to user-defined lengths to selectively position the center stations along the axis of the boring bar. In the illustrated embodiment center stations 14b and 14c are immediately adjacent each other.

Each center station 14 houses an adjustable-length nut 20 that enables fine adjustment of the axial position of the center station along the bar. An end cap 22 attached to the lower end of the bar 12 compresses the center stations 14, collars 18, and nuts 20 against the bar shoulder 16.

Attached to each center station 14 is a pair of diametrically-opposed wings 24 (for clarity the wings attached to center station 14c are omitted from the drawings). Wings 24 extend radially away from their respective center stations. Mounted on the outer end of each wing 24 is an indexible insert cartridge 26 that mounts a cutting insert (not shown) in a conventional manner (for clarity some of the insert cartridges are omitted from the drawings). Insert cartridge 26d is directly attached to wing 24d. Insert cartridge 26b is attached to an insert cartridge spacer 28 that is directly attached to wing 24b. A fine diameter adjustment device 30 (see FIGS. 29 and 30) carried in each wing 24 enables fine adjustment of the radial position of the insert cartridges 26.

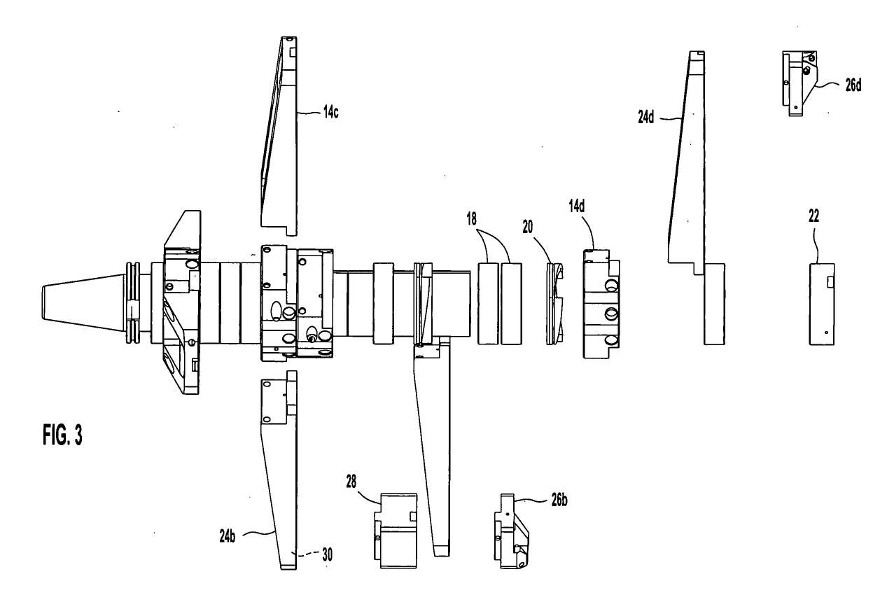

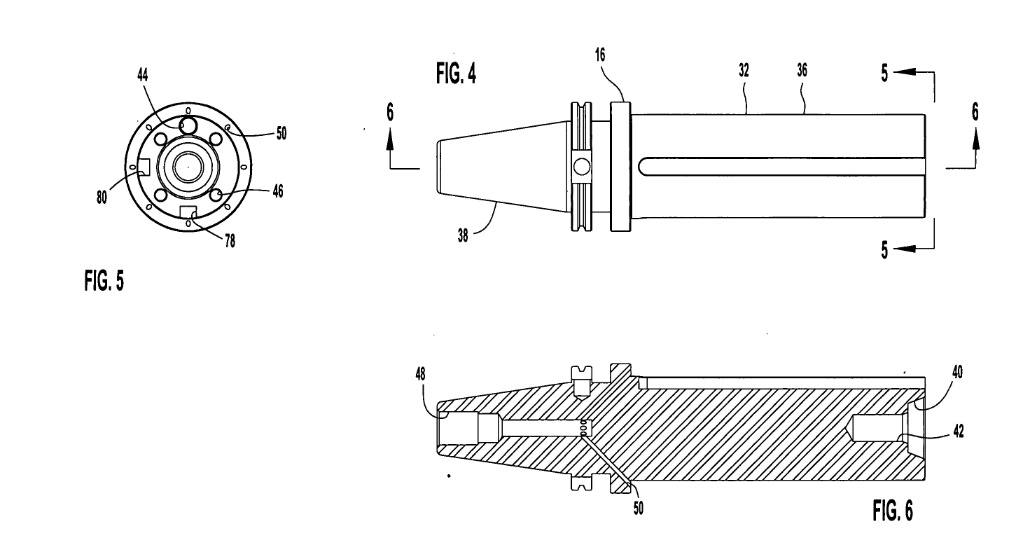

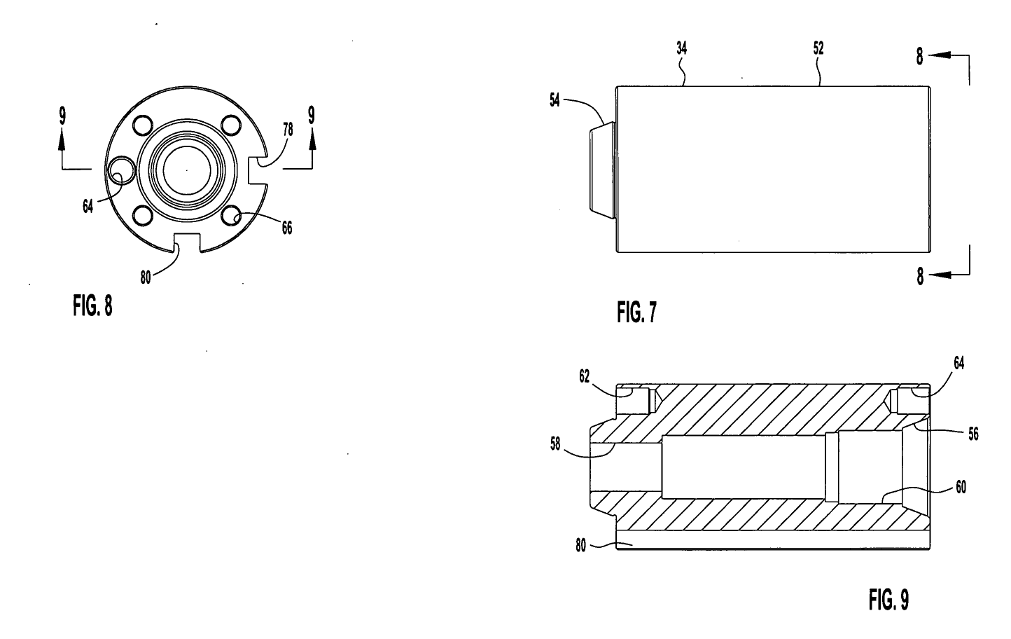

Boring bar 12 includes a boring bar slug or base 32 shown in FIGS. 4-6, and optionally one or more bar extensions 34 shown in FIGS. 7-9. The bar extensions 34 extend the length of the boring bar 12 as needed, allowing the user to lengthen the entire interchangeable system along its axial direction. The user can determine the amount of extensions needed for a specific task and add or subtract extensions accordingly. Boring bar extensions 34 can be manufactured in different lengths.

The boring bar slug 32 consists of a straight bar or cylindrical body 36 having an integral tapered shank 38 adjacent the shoulder 16. Shank 38 is inserted into a machine tool via the spindle as in a milling machine or, in turning applications, the shank 38 is placed in a tool holder such as those used on a turret of a lathe. The other end of the boring bar slug 32 includes a tapered female receptacle 40 and a centered bolt hole 42 to attach a bar extension 34 (if used) A pin hole 44 receives a dowel pin (not shown) that circumferentially aligns and nonrotatably connects the boring bar slug 32 and the adjacent bar extension 34. If a bar extension is not used, four bolt holes 46 receive bolts (not shown) that mount the end cap 22 to the end of the boring bar slug 32.

The boring bar slug 32 supplies coolant to the boring bar assembly 10 via a central coolant inlet passage 48 extending into the shank 38. A number of circumferentially spaced coolant ports 50 are drilled into the shoulder 16 and intersect the inlet passage 48. Coolant supplied through the inlet passage 48 is distributed out the shoulder 16 and delivered to any part mating against the shoulder as will be described in greater detail below.

Each boring bar extension 34 consists of a straight bar or cylindrical body 52 having a male tapered boss 54 at one end and a tapered female receptacle 56, like receptacle 40, at the other end. Boss 54 mates or locks with the slug receptacle 40 or another extension receptacle 56, effectively maintaining maximum surface contact for each locking part. The extension is tightened to and combined with the adjacent boring bar slug or extension by a single large bolt (not shown), which resides in a counter-bored hole 58 inside the center of the extension 34. A threaded insert (not shown) is threaded into an enlarged-diameter threaded portion 60 to allow an additional extension 34 to be mated to the extension 34 if needed. Pin holes 62, 64 on each end of the body 52 receive a dowel pin (not shown) that circumferentially align and nonrotatably connect the bar extension 34 with the adjacent bar slug 32 or bar slug extension. If the extension 34 is on the end of the boring bar 12, bolt holes 66 receive bolts that mount the end cap 22 to the extension.

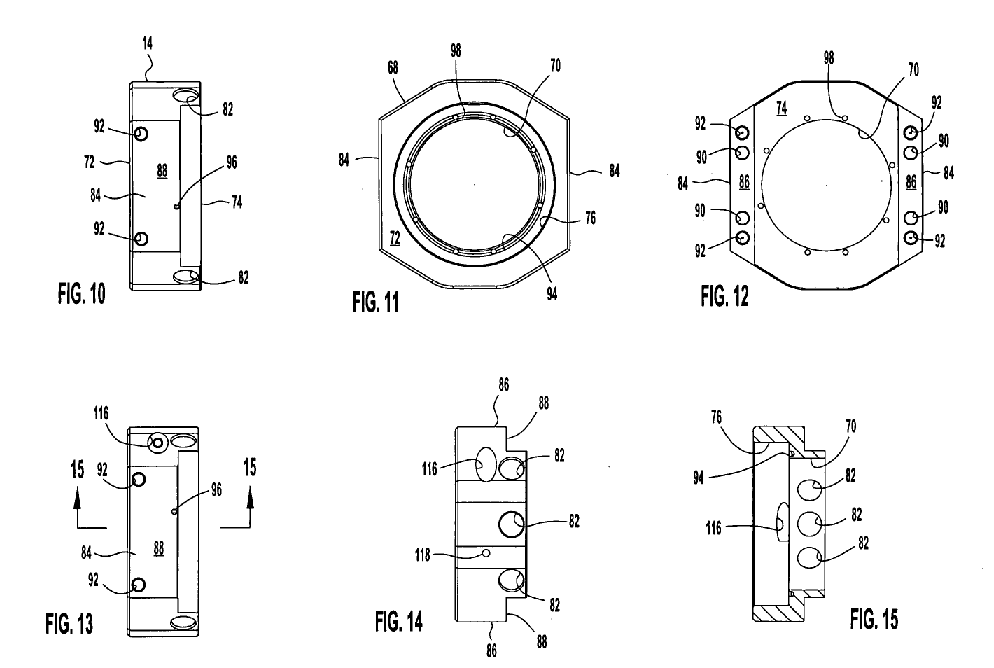

Each center station 14 slides over the boring bar 12 to locate the center station along the bar. A center station 14 has an annular body 68 having a bored hole 70 through the center. See FIGS. 10-15. Hole 70 is machined to allow a slip fit between the boring bar 12 and the center station 14. Body 68 has flat inboard and outboard faces 72, 74 that engage against or mate against the bore bar shoulder 16, collars 18, other center stations 14, adjustable-length nut 20, or the end cap 22 when mounted on the boring bar 12. An enlarged-diameter counterbore 76 on the inboard face 72 houses the adjustable length nut 20 associated with the center station.

The center station 14 holds the attached wings 24 not only at a specific axial location along the boring bar 12, but also holds the wings at a specific circumferential orientation on the bar. To that end, the boring bar slug 32 and each boring bar extension 34 includes a pair of axial grooves 78, 80 separated by 90 degrees (see FIGS. 5 and 8). Six threaded drive holes 82 are circumferentially spaced around the outer periphery of the body 68 and extend through the radial thickness of the body. A threaded drive pin (not shown) is held in one user-selected hole 82. The drive pin extends into the groove 78 or 80 and non-rotatably connects the center station 14 to the boring bar 12 at a fixed angular orientation with respect to the boring bar. The drive pin also enables the boring bar 12 to drive the center station 14. The six drive holes 82 and the two grooves 78, 80 provide twelve user-selectable positions or circumferential orientations of the center station 14 on the bar 12. For example, center station 14b and 14c are circumferentially offset from each other with respect to the boring bar 12 (see FIG. 1).

The center station 14 is configured to hold two wings 180 degrees apart, and includes a pair of like wing mounting stations 84 diametrically opposite each other on body 68. Each station 84 is formed as a slot defining perpendicular mounting surfaces 86, 88. Mounting surface 86 includes a pair of pin holes 90 that position the wing onto the mounting station. Four bolt holes 92—two on surface 86 and two on surface 88—fasten the wing to the mounting station.

The center station 14 also flows coolant to the wing mounting stations 84. An annular coolant channel 94 surrounds the bottom of counterbore 76 facing the opening. A pair of radial coolant holes 96 extend radially from the channel 94 and open on respective wing mounting surfaces 88. A number of circumferentially-spaced axial coolant holes 98 extend from the coolant channel 94 through the thickness of the body to flow coolant downstream to the next outboard center station 14 or the end cap 22.

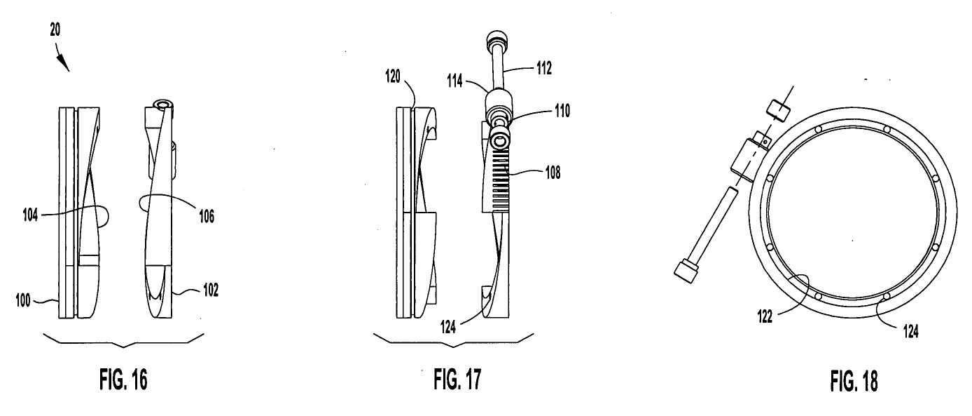

The adjustable-length nut 20 is shown in FIGS. 16-18 and permits fine positioning adjustments of the center station 14 along the boring bar 12. The nut 20 includes an upper, or inboard, cam adjuster 100 and a lower, or outboard, cam adjuster 102. The cam adjusters have facing cam surfaces 104, 106 that cooperatively engage to vary the length of the nut upon relative rotation of one surface with respect to the other. The outboard cam adjuster 102 includes a gear tooth profile 108 provided around one-third of the outside diameter on the cam adjuster. This profile mates with a worm 110 housed inside the center station 14 driven by worm screw 112 and supported in worm spacer 114. The head of the worm screw is accessible through an adjustment hole 116 extending through the center station 14 (see FIG. 14). Anti-rotation pins (not shown) provide positive positioning of the inboard cam adjuster 100.

By rotating the worm screw 112, the nut 20 will extend or retract into and out of the center station 14, increasing or decreasing the length of the nut 20. When the nut 20 is at its shortest length, it is housed fully within the center station counter bore 76, enabling part-to-part contact between center station and center station or center station and collar. A lock screw (not shown) is carried in a threaded lock hole 118 extending through the center station body (see FIG. 14) to provide a positive locking mechanism. This prevents the loosening of the worm and cam adjuster assembly while permitting the user to freely adjust and lock the cam adjuster as needed.

Around the outside diameter of the adjusting nut 20 is a machined groove 120 in which an O-ring (not shown) retains internal coolant losses. An annular coolant channel 122 and concentric, axial coolant holes 124 provide multiple unobstructed paths for the coolant to flow forward to subsequent mating parts.

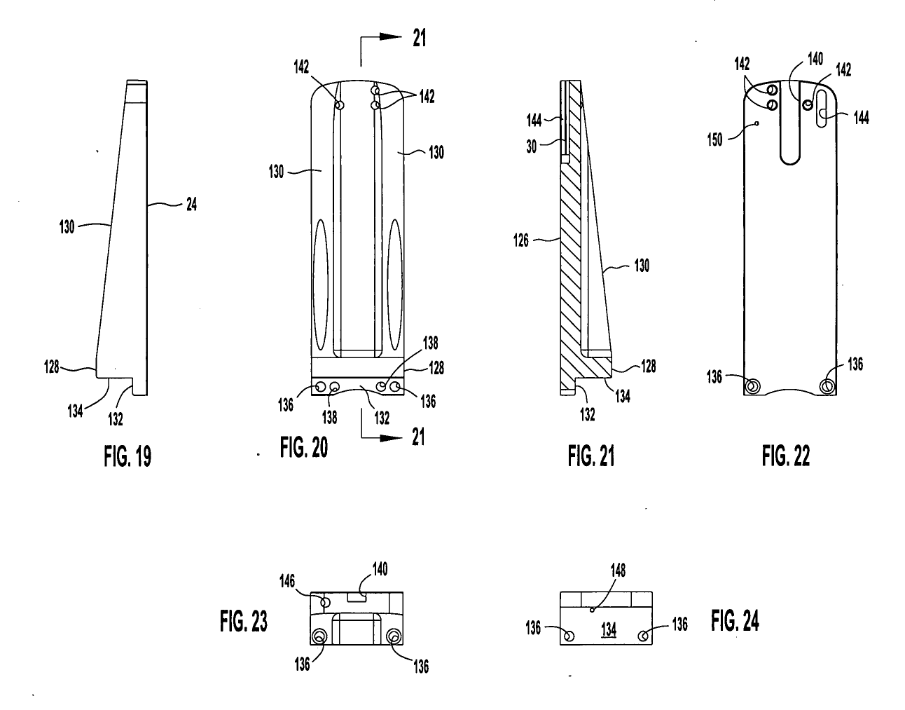

One wing 24 of the boring bar assembly 10 is shown in FIGS. 19-24. Wings 24 are extensions that, in the illustrated embodiment, act as platforms for mounting indexible insert cartridges 28. Wings are manufactured in varying lengths, allowing the user to select the proper length wing for the appropriate intended cutting diameter. The wing preferably employs a tapered design, which adds additional strength to the extremity of the boring bar assembly 10. Wings 24, however, can mount other tools that drill, center, ream, mill, turn, face, thread, chamfer, countersink, counterbore, groove, debur, grind, flow coolant, or perform other types of machining and finishing operations in other embodiments of the boring bar assembly 10.

Wing 24 includes a body 126 formed as a generally flat, elongate plate having a mounting flange 128 extending from near the lower end of the plate. A pair of stiffening ribs 130 extend from the flange along the upper side of the plate. Perpendicular mounting surfaces 132, 134 formed on the plate and flange respectively support the wing against respective station mounting surfaces 86, 88. Mounting surfaces 132 and 134 each includes a pair of through bolt holes 136 that allow bolts (not shown) to be threaded into station mounting bolt holes 92 to fasten the wing to the center station. Pin holes 138 on mounting surface 133 cooperate with the station mounting pin holes 90 to capture dowel pins (not shown) that position the wing on the mounting station before the bolts are tightened.

The lower side of flat plate 126 is flat, with the upper end of the plate configured to mount an indexible insert cartridge 28. A radial alignment slot 140 open to the lower side of the plate has three threaded bolt holes 142 arranged along the slot to fasten the indexible insert cartridge 28 to the wing. A second radial slot 144 adjacent to and parallel with the alignment slot 140 houses the fine diameter adjustment device 30 associated with the wing 18. Upper hole 146 opens into slot 144 and provides access to the adjustment device 30.

A groove on the side of the slot 140 aids retention of the insert cartridge 26 while making radius adjustments. The groove resists separation of the insert cartridge and wing, decreasing the possibly of debris contamination between the mating surfaces of the wing and insert cartridge.

Wing 24 flows coolant from the wing mounting station 84 to the indexible insert cartridge 28. A radial coolant channel 148 extends substantially the length of the plate 126 and is fluidly connected to the mounting station cooling hole 96 when the wing is mounted on the center station. Coolant channel 148 discharges at a coolant nozzle or coolant discharge hole 150 on the lower surface of the plate adjacent bolt holes 142.

When assembled on a center station 14, the lower side of the wing body 126 is parallel and coincident with the outboard side or face 72 of the center station. This allows unimpeded stacking of center station and wing assemblies to adjacent assemblies or parts.

The indexible insert cartridges 26 can be considered the working hands of the interchangeable boring system, mainly due to its cutting ability. An insert cartridge 26 can be configured to hold practically any style insert of current and foreseeable future designs. The illustrated insert cartridge 26 is designed to hold a conventional cutting insert (not shown). The cutting insert is positioned to the front of the cartridge or the outer most radial position to engage itself into the material being removed. Any clamping method could be employed to retain the insert on the cartridge.

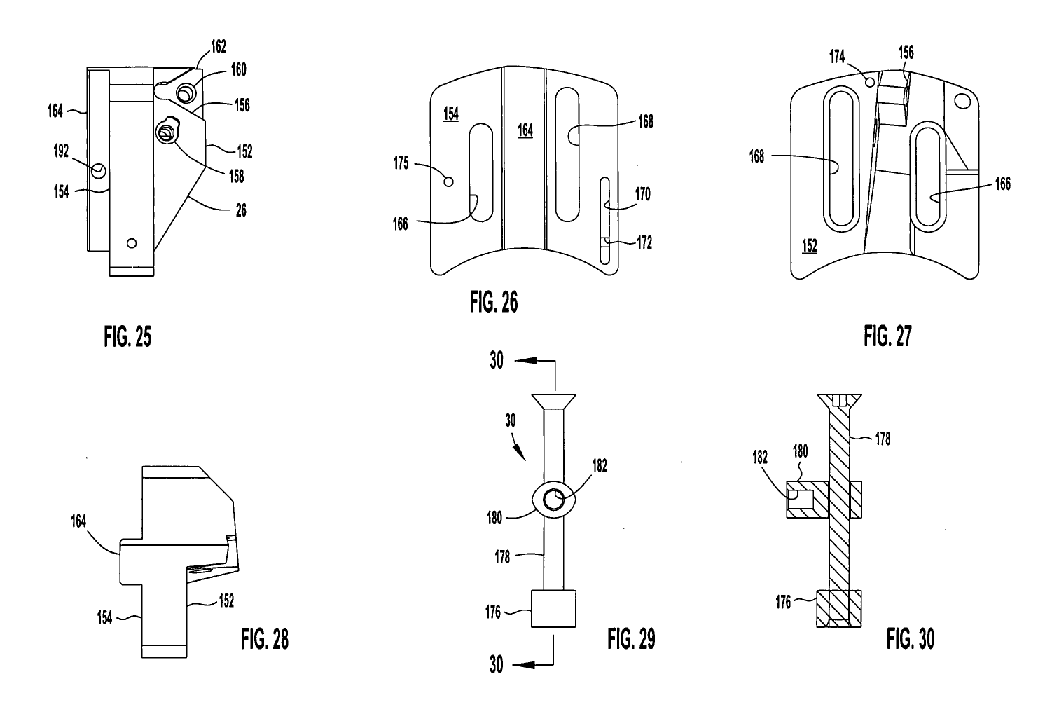

Insert cartridge 26 includes a front face 152 configured to removably hold the cutting insert and an opposite flat rear face 154 that mounts cartridge 28 on wing plate 126. See FIGS. 25-28. A recess 156 for an insert shim and cutting insert, a swing arm clamp screw hole 158, and an insert screw hole 160 are provided on the front face 152. The radially outer surface 162 extending away from the front face 152 has a five-degree relief angle.

A radial alignment rib or key 164 extends from the rear face 154 and is configured to slide in wing radial alignment slot 140. The integral key 164 aligns the insert cartridge 26 to a specific geometry with respect to the wing 24, and maintains the position of the insert cartridge in a rigid fashion even under severe conditions. Elongate upper and lower clamping slots 166, 168 extend through the thickness of the insert cartridge 28 and overlay wing bolt holes 142 when the alignment key 164 is in slot 140. The slots 166, 168 receive three bolts (not shown) that are received in wing bolt holes 142 to clamp the insert cartridge 26 on wing 24. The elongate slots permit radial adjustment of the cartridge 26 on wing 24.

The insert cartridge 26 flows coolant from wing coolant discharge 150 and includes an elongate coolant slot 170 that fluidly communicates with the wing discharge 150. The coolant slot 170 receives flow from the discharge 150 for all operating positions of the insert cartridge on the wing 24. A coolant channel 172 extends from the coolant slot 170 to a coolant discharge port 174 adjacent the insert recess 156 and directs coolant against the cutting edge during machining operations.

The illustrated embodiment employing the insert cartridges 26 is not intended to be a limiting example; other attachments and metal removing tools can be attached to the boring bar in alternative arrangements and in alternative order in other embodiments of the boring bar assembly 10.

A fine diameter adjustment pin hole 175 on the rear face 154 adjacent key 164 receives a pin (not shown) that protrudes from the insert cartridge 26. The pin extends into the wing 24 and mates with the fine diameter adjustment device 30 for fine radial adjustment of the insert cartridge 26 along wing 24. The adjustment device 30, shown in FIGS. 29 and 30, includes an adjustment screw collar 176 in the wing slot 144. A threaded adjustment screw 178 is supported in slot 144 by the collar 176. The head of the adjustment screw 178 is accessible through wing access hole 146. Rotating the screw 178 drives adjustment pin holder 180 along the screw. The pin holder 180 includes a pin bore 182 that receives the pin protruding from the insert cartridge 26 to drive the insert cartridge.

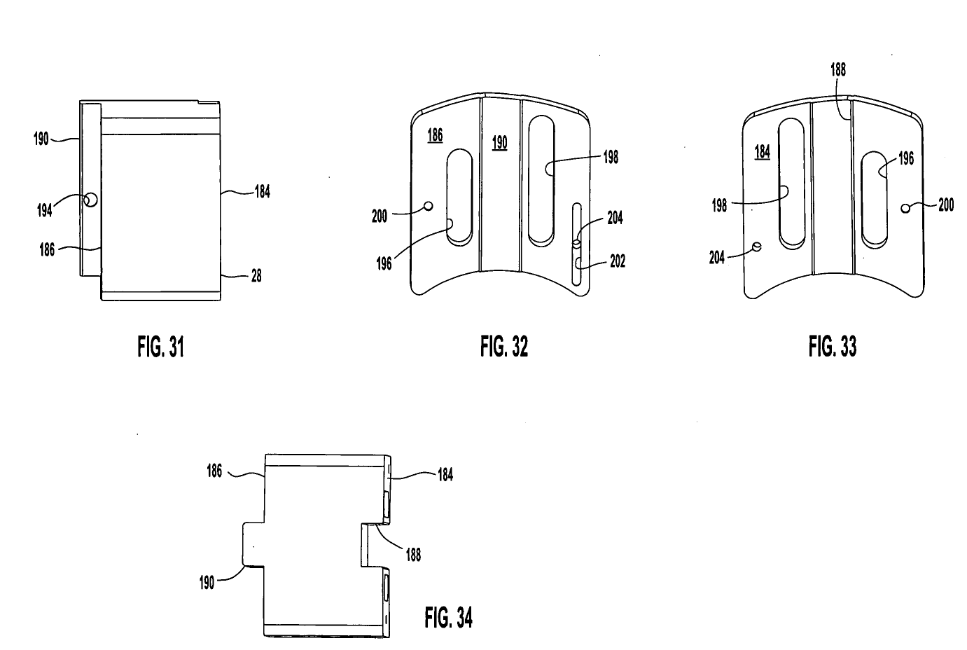

Indexible insert cartridge spacers 28 are employed to elevate axially or axially offset the indexible insert cartridges 26 along the boring bar 12. This gives the user the ability employ many cutting edges on the same cutting plane, even if the insert cartridges holding the cutting edges are carried on different center stations. As shown in FIGS. 31-34, an insert cartridge spacer 28 includes opposite side faces 184, 186 separated by the thickness of the spacer. The outboard face 184 has a radial alignment slot 188, like wing alignment slot 140, to receive spacer alignment key 164. The inboard face 186 includes a radial alignment key 190, like insert cartridge key 164, that is received in the wing slot 140.

A detent pin hole 192 through the index cartridge key 164 (see FIG. 25) enables a detent pin (not shown) to locate the index cartridge 26 on the cartridge spacer 28. The detent pin provides precise placement of replacement indexible insert cartridges, giving the user the ability to interchange cartridges and still maintain relative accuracy and repeatability. A like detent pin hole 194 on the spacer key 190 enables multiple spacers 28 to be mounted between the wing 24 and the index cartridge 26.

Elongate upper and lower clamping slots 196, 198 extend through the thickness of the cartridge spacer 28. The slots permit mounting bolts to extend through both the insert cartridge 26 and insert cartridge spacer 28 when attaching the cartridge and cartridge spacer to the wing 24. The elongate slots 196, 198 permit radial adjustment of the cartridge spacer 28 on the wing 24; the insert cartridge 26 and the spacer 28 move as one unit when adjusted. The cartridge spacer 28 includes a fine diameter adjustment pin hole 200 that enables the fine diameter adjustment device 30 to make fine adjustments of the radial location of the insert cartridge and cartridge spacer unit.

Cartridge spacers 28 can be manufactured in various thicknesses to meet positioning requirements. Each spacer 28 is preferably provided with its own set of mounting bolts having sufficient length to mount the spacer and insert cartridge to a wing.

Coolant is ported through the insert spacer 28 to the insert cartridge 26 by elongate coolant travel slot 202 and coolant channel 204. Coolant slot 202 overlays wing coolant discharge 150 and channel 204 fluidly connects the coolant slot 202 with the insert cartridge coolant slot 170 when the insert cartridge 26 and the insert spacer 28 are installed on the wing 24.

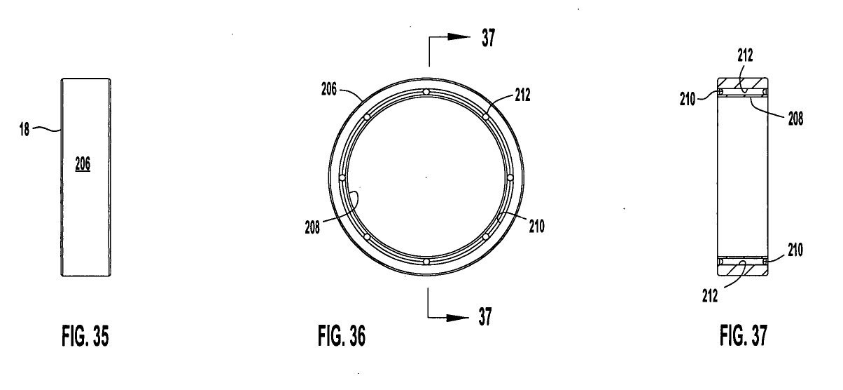

One collar 18 of the boring bar assembly 10 is shown in FIGS. 35-37. Collar 18 includes a tubular body 206 with a concentric through bore 208. Bore 208 is sized to enable the collar 18 to slide along the boring bar 12. Each side of the collar 18 includes an annular coolant channel 210 surrounding the bore. The coolant channels 210 are connected by a number of axial coolant channels 212, enabling coolant to flow through the collar to subsequent component parts. Collars 18 can be manufactured in various lengths to meet positioning requirements, and multiple collars can be stacked together along the length of the boring bar 12 as shown in FIG. 1. Essentially infinite positioning of multiple center stations onto a single boring bar 12 can be achieved by stacking collars and center stations as needed.

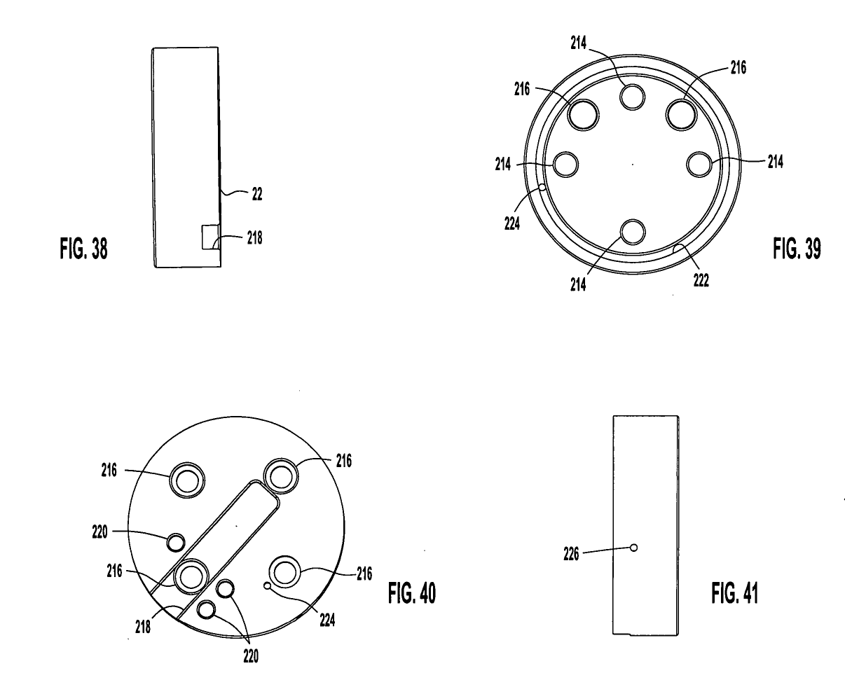

End cap 22 is shown in FIGS. 38-41. The end cap 22 fastens to the end of the boring bar 12, essentially holding the components tightly together by applying compression to the center stations, adjusting nuts, and collars against the shoulder 16. The end cap 22 includes a cylindrical body having four axial through bolt holes 214 that retain the end cap 22 on the boring bar slug 32 or the boring bar extension 34. The illustrated end cap 22 is also capable of holding an insert cartridge 26, allowing the user to place a cutting edge on a smaller radius circle. A radial alignment slot 216 and threaded bolt holes 218 on the outer end of the end cap have the same configuration as corresponding mounting structure on a wing 24. An annular coolant channel 220 and an axial coolant channel 222 flow coolant to the insert cartridge. A radial coolant channel 224 intersecting axial channel 222 is also provided.

In use the illustrated the boring bar assembly 10 is attached to a machine tool (not shown) in a conventional manner by the shank 38. Cutting inserts carried on center stations 14b and 14c are located on the same cutting circle, enabling multiple cutters on multiple center stations to simultaneously machine a bore. This is achieved by attaching identically-sized wings to center stations 14b and 14c. The insert cartridges carried by center station 14c are attached directly on the wings. The insert cartridges carried by center station 14b are carried on insert cartridge spacers 28. The cartridge spacers 28 have a length equal to the length of the center station 14c, thereby locating the insert cutters on the same cutting plane as the cutting inserts carried by center station 14c. Center station 14b is circumferentially offset from center station 14c so that the insert cartridges do not axially obstruct one another.

Coolant flows from the center bar slug 32 through slug cooling ports 50 and flows axially to the end cap 22 through the center stations 14, adjustable nuts 20, and collars 18. Coolent also flows radially from each center station 14 to the cutting edges through the wings 18, cartridge spacers 28 (if present) and insert cartridges 26 before being discharged against the cutting edges. Unused center station wing mounting stations have covers bolted on them to plug the coolant channels, and unused coolant channels in the end cap 22 are also covered or plugged.

The interchangeable boring bar system of the present invention allows a practically infinite number of configuration possibilities. In operation a user uses a boring bar assembly assembled with the system, such as the boring bar assembly 10, in a normal manner. The user can, when desired, interchange, attach, or adjust the components of the boring bar system to provide a different configuration of multiple diameters, lengths of cuts, and types of machining or finishing operations. Users may also interchangeably attach to the end of the boring bar 12 or the end cap 22 tools that drill, center, ream, mill, turn, face, thread, chamfer, countersink, counterbore, groove, debur, grind, flow coolant, or perform other types of machining and finishing operations.

The versatility of the interchangeable boring bar system enables a user to create a boring bar assembly suitable for a wide variety of job-specific applications. The following outline presents a method of assembling a boring bar assembly 10:
1) Determine the overall length of the boring bar needed to perform all required operations.
   a) The required will establish the need for no bar extensions or one or more bar length extensions. If an extension is needed, choose the shortest length extension or extensions combined that can perform the job function.
   b) If extensions are needed, place the required extension or extensions in the following manner:
      b1) Place the required drive pin in the end of the orientation pinhole on the end of the boring bar slug.
      b2) Place the required threaded inserts into the boring bar extension and tighten snugly.
      b3) Place the male end of the extension into the female end of the boring bar.
      b4) Place the required extension bolt into the female end of the extension and tighten together snugly.
   c) If additional extensions are needed repeat steps b1 through b4, adding drive pins to nonrotatably connect the bar extensions.
2) Determine the number of bores or counter bores needed to complete the task.
   a) The amount of bores to be performed in a single operation will correspond to the number of center stations on the boring bar. The number of center stations, however, may not correspond in a one-to-one correspondence to the number of bores. For example, a user could configure the boring bar system to bore two bores having different diameters and having different depths on the same center station. This is accomplished by adding a cartridge spacer to a corresponding wing and locating the insert cartridge in a different radial position. Alternatively, more than one center station can mount insert cartridges to cut the same bore as exemplified by center stations 14b and 14c.
3) Determine the amount of material removal for each bore or counter bore.
   a) This may depend on many factors, including casting deviations, bore placement, type of material to be removed, and the like.
   b) The user may want to consult the boring bar manufacturer or the insert manufacturer to gain a rough idea of material removal parameters, or consult with others having prior experience in material removal.
   c) Typically the user will divide large amounts of material removal by the use of two or more cutting edges and possibly between two or more center stations.
4) Determine the spacing or distance between each bore or counter bore.
   a) The user will choose appropriate collars and cartridge spacers for the axial spacing of the cutting edges. The adjusting nuts 20 permit fine axial adjustments of each of the center stations.
5) Determine the diameter of each cut.
   a) The user will choose appropriate wings to match the needed diameter of each cut. The fine diameter adjustment devices 30 enable fine radial adjustments of the adjustments of the radial locations of each of the indexible insert cartridges or indexible insert cartridge and indexible insert cartridge spacer units.
6) Begin bar assembly.
   a) Starting at the top of the bar, slide either a center station or the appropriate collar down to the base of the boring bar slug. If you have a blind hole, which the end of the bar will have no obstructions to encounter while machining, start with a center station to maintain maximum bar rigidity and performance.
      a1) While placing the center stations, ensure the adjusting nut is placed towards the base of the bar system. Position the adjusting nut in the required position to attain the appropriate axial position. Tighten the adjusting nut lock screw securely to prevent axial movement of the center station, and rotate the center station to one of the twelve different drive positions. Insert the drive pin into the corresponding center station drive pin hole, and confirm that the pin is fully entered into the drive slot of the boring bar slug or bar extension. Place coolant plugs in the rest of the drive pin holes on the center stations and tighten securely.
   b) Slide the appropriate width collar or collars or another center station down against the already positioned part or parts on the bar.
   c) Repeat steps 6a and 6b until the top of the entire system is reached.
   d) Place any optional attachments or an end cap onto the end of the bar system. Optional attachments may use a similar attachment system as used for attaching bar extensions, for attaching the end cap, or an alternative method of attachment. The slidably mounted parts of the system should be tightly pressed against the boring bar shoulder.
      d1) When attaching an end cap place the end cap over the end of the bar system, place the drive pin into the orientation pin hole, insert bolts through the end cap into the boring bar slug or bar extension, tighten bolts securely, and ensure there is no gap between the end cap and the last axially mounted collar or center station. The end cap should fit tightly to press against all slidably mounted parts of the system.
   e) Starting with the first center station near the base of the system, attach the appropriate wing or wings. Wings are made of multiple lengths to accommodate different diameters.
      e1) Each wing is attached by inserting the alignment pins into the center station, mating the alignment pins with the alignment pin holes on the wing, attaching two axially and two radially bolts through the wing into the center station, and tightening securely. Attach the remaining wings in like manner.
   f) Starting with the first wing near the base of the bar, attach either an indexible insert cartridge or an indexible insert cartridge spacer and indexible insert cartridge combination.
      f1) Each indexible insert cartridge is attached using the adjustment pin for alignment whether onto a wing or onto an indexible insert cartridge spacer. Place either the indexible insert cartridge or the indexible insert cartridge spacer onto the wing and onto the alignment slot. If using an indexible insert cartridge spacer attach the indexible insert cartridge onto the indexible insert cartridge spacer in the same aforementioned manner. If no spacer is used, use the indexible insert cartridge bolts to attach directly to the wing and tighten securely. If using the spacer, insert the bolts that come with the spacer into the indexible insert cartridge, through the indexible insert cartridge spacer, and into the wing, and tighten securely.
      f2) If attaching an indexible insert cartridge to an end cap, use the end cap alignment slot to position the cartridge onto the end cap, manually locate the radial position of the cartridge. Attach bolts through the indexible insert cartridge into the end cap. Tighten securely.

While I have illustrated and described a preferred embodiment of my invention, it is understood that this is capable of modification, and I therefore do not wish to be limited to the precise details set forth, but desire to avail myself of such changes and alterations as fall within the purview of the following claims.

1. An interchangeable boring bar system comprising:
a boring bar defining an axis;
a center station slidably mounted on the boring bar for movement along the axis;
a first connection positioning the center station at a selected axial position on the bar;
a second connection non-rotatably connecting the center station to the boring bar at the selected position;
a wing removably attached to the center station and extending radially away from the center station; and
an implement holder attached to the wing configured to hold an implement to be driven by the boring bar;
whereby the implement holder is positioned at a user-selected radius and axial position with respect to the boring bar.

2. The boring bar system of claim 1 wherein the boring bar comprises a bar slug on one end of the boring bar and at least one extension removably mounted to the bar slug.

3. The boring bar system of claim 1 comprising a flow line comprising an inlet port on an end of the boring bar and a discharge port on the implement holder, the flow line extending through the boring bar and wing to flow liquid to the implement holder.

4. The boring bar system of claim 1 wherein the first connection comprises at least one collar slideably mounted on the boring bar.

5. The boring bar system of claim 1 wherein the first connection comprises an adjustable-length assembly.

6. The boring bar system of claim 1 wherein the boring bar comprises an annular shoulder adjacent one end of the bar and an end cap on an opposite end of the bar urging the center station towards the shoulder.

7. The boring bar system of claim 1 wherein the second connection comprises at least one axial groove in the boring bar and a member extending from the center station into the groove.

8. The boring bar system of claim 1 wherein the implement holder is removably attached to the wing.

9. The boring bar system of claim 8 comprising a spacer between the wing and the implement holder to axially offset the implement holder from the wing.

10. The boring bar system of claim 1 comprising an additional center station, an additional wing mounted to the additional center station, and an additional implement holder mounted to the additional wing wherein the implements held by the implement holders are located in a common radial plane.

11. The boring bar system of claim 1 comprising an additional wing attached to the center station and an additional implement holder mounted to the additional wing wherein the implements held by the implement holders are circumferentially offset from each other.

12. The boring bar system of claim 1 wherein the boring bar comprises a shank end and an opposite end, the opposite end configured to mount an additional implement holder.

13. The boring bar system of claim 1 comprising a first flow line comprising an inlet port on an end of the boring bar and extending through the first connection and the center station to flow fluid axially along the boring bar, and a second flow line extending from the first flow line through the center station, wing, and implement holder.
